(19) United States
(12) Patent Application Publication
(10) Pub. No.: US 2022/0027845 A1
(43) Pub. Date: Jan. 27, 2022

(54) PACKAGE DELIVERY PROTECTION BASED ON PREFERENCE FEEDBACK

(71) Applicant: International Business Machines Corporation, Armonk, NY (US)

(72) Inventors: Zachary A. Silverstein, Jacksonville, FL (US); Lisa Seacat DeLuca, Baltimore, MD (US); Jeremy R. Fox, Georgetown, TX (US)

(21) Appl. No.: 16/939,808

(22) Filed: Jul. 27, 2020

(51) Int. Cl. G06Q 10/08; G06F 16/2457; G06F 16/248

(52) U.S. Cl. CPC G06Q 10/0833; G06Q 10/0832; G06F 16/248; G06F 16/24578; G06Q 10/0838

(57) ABSTRACT

A method provides for a first computing device to receive a ranking of delivery location images associated with a delivery address in which the ranking is based on the feedback of preference of delivery locations of prior deliveries. The first computing device generates a ranking of a plurality of respective delivery locations based on the preference feedback of prior delivery locations. The first computing device receives information associated with delivery to the delivery address and determines a delivery location associated with the delivery address having a highest-ranking of preference, based on the preference feedback of prior deliveries associated with the respective delivery locations. The first computing device sends an image of the delivery package placed in the highest-ranking delivery location, to a second computing device associated with the delivery address, and the first computing device receives feedback of preference of the delivery location from the second computing device.

### FIELD OF THE INVENTION

The present invention relates generally to the field of adaptive behavior based on historic feedback, and more particularly to an evolution of package delivery protection based on preference feedback.

### BACKGROUND OF THE INVENTION

Consumer behavior of purchasing physical items has been influenced by the ease and convenience of searching online for suppliers of items to purchase. Online ordering has the advantages of avoiding the cost, time, and travel logistics of purchasing from brick and mortar stores, although issues such as size, fit, and return logistics have traditionally been a deterrence. The Courier, Express, and Parcel (CEP) markets include companies that provide logistics and delivery services for parcel or packages too large or heavy for normal letter postal delivery. Recent advancement in the delivery time provided by CEP services for online purchases has significantly reduced concerns regarding wait-time until a purchased item is received, with some deliveries available within hours, and many within two days.

Delivery couriers are often required to meet the accuracy of delivery location and the timeliness of delivery schedule with seldom interacting with individual recipients. Often the delivery personnel for a particular delivery area may change or alternate between multiple individuals. Similarly, recipients seldom have contact with delivery personnel and discussion pertinent to delivery is effectively absent. Improvements in the delivery of online purchases may not replace all brick and mortar shopping; however, indications are that the increasing trend of online purchasing will continue.

### SUMMARY

Embodiments of the present invention disclose a method, computer program product, and system. The embodiments include a method to determine a preferred delivery location in which to place a delivery package. The method provides for a first computing device to receive a ranking of delivery location images associated with a delivery address in which the ranking is based on the feedback of preference of respective delivery locations among a plurality of delivery locations at the delivery address during prior package deliveries. The first computing device generates a ranking of the plurality of respective delivery locations based on the feedback of the preference of respective delivery locations. The first computing device receives information associated with the delivery of a first package to the delivery address. The first computing device determines a first delivery location associated with the delivery address and having a highest-ranking of preference, based on the feedback of the preference of respective delivery locations. The first computing device sends a first image of the first delivery package placed in the first delivery location, to a second computing device associated with the delivery address, and the first computing device receives the first feedback of preference of the first delivery location from the second computing device.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a location preference module as a component of a delivery location program of FIG. 3, in accordance with embodiments of the present invention.

FIG. 3 is a flowchart depicting operational steps of the delivery location program, operating in the distributed data processing environment of FIG. 1 and includes the location preference module of FIG. 2, in accordance with embodiments of the present invention.

FIG. 4 depicts a block diagram of components of a computing system, including a computing device configured with the capability to operationally perform the location preference module of FIG. 2 and delivery location program of FIG. 3, in accordance with an embodiment of the present invention.

### DETAILED DESCRIPTION

Embodiments of the present invention recognize that increases in online purchases result in greater demand for package delivery to ordering business and residence addresses. Embodiments also recognize that the increase in delivered items, which are typically package deliveries, is accompanied by an increase in stolen packages by thieves sometimes referred to as “porch pirates.” Embodiments recognize that delivered packages are often placed in open, obvious locations or positions at the delivery address, which further enables recognition and theft by malevolent persons. Hiding of delivered packages by a delivery courier may help to reduce theft of delivered packages, but the recipient user may be unaware of the delivery or struggle to locate the delivered package. In some cases, hiding the package may submit the package contents to unfavorable conditions that have negative consequences on the package contents.

Embodiments of the present invention disclose a method, computer program product, and computer system for improving the protection of delivered packages based on determining preferred locations or positions at a delivery address to facilitate obscuring the delivered packages. Embodiments include building a model that prioritizes delivery locations at a particular delivery address by preference levels received from feedback associated with a plurality of delivery location images that respectively depict a delivery location. The feedback associated with the received delivery location images indicates a positive or negative preference level as feedback, thus building a set of preferences of delivery locations that can be ranked. In some embodiments, the feedback associated with the delivery location image includes information associated with attributes of the package delivered, such as size, shape, weight, exterior pattern, perishable contents, or undesired exposure of the package to weather or other potentially harmful conditions (i.e., lawn sprinkler).

In some embodiments of the present invention, the model prioritizing optimal delivery locations at a particular address includes building a feedback-related score associated with respective delivery locations. The feedback is accumulated over multiple deliveries in which a delivery courier generates an image of the package placed in a chosen delivery location, and in some cases, annotates or marks the image for further clarity, and sends the image to the recipient. The recipient provides the feedback indicating a positive or negative response to the chosen delivery location, thus building sets of feedback associated with respective delivery locations. In some embodiments, the delivery courier may further respond to feedback from the recipient for instances in which a preferred location is inconvenient or inappropriate for the delivery courier.

Embodiments of the present invention generate a ranking of delivery locations for the particular address, based on the feedback. Delivery couriers performing subsequent delivery of packages to the particular address select a delivery location indicated by the ranking of the respective delivery location images. In some embodiments, the selection of the delivery location is based on the ranking of respective locations in combination with information associated with the package to be delivered, such as the package size, shape, weight, and conditions for special handling.

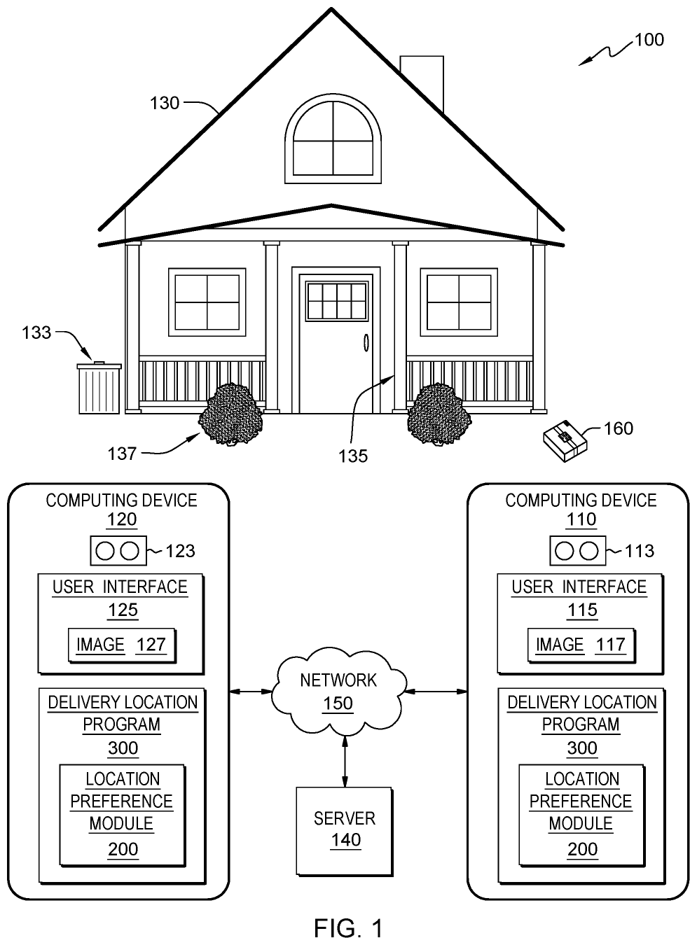

The present invention will now be described in detail with reference to the Figures. FIG. 1 is a functional block diagram illustrating a data and feedback processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Data and feedback processing environment 100 includes computing device 110, computing device 120, delivery address dwelling 130, disposal container 133, support column 135, yard plant 137, server 140, and delivery package 160. Computing device 110, computing device 120, and server 140 are all interconnected via network 150.

Network 150 can be, for example, a local area network (LAN), a wide area network (WAN), such as the Internet, a virtual local area network (VLAN), or any combination that can include wired, wireless, or optical connections. In general, network 150 can be any combination of connections and protocols that will support communications between computing device 110, computing device 120, server 140, location preference module 200, and delivery location program 300, in accordance with embodiments of the present invention.

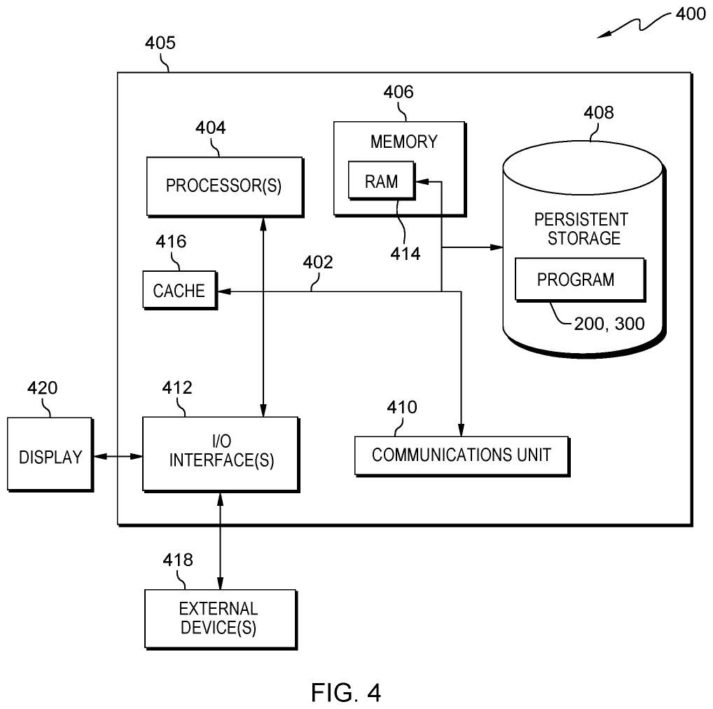

Computing device 110 includes camera 113, user interface 115, image 117, and delivery location program 300. In some embodiments, computing device 110 is a standalone mobile computing device, a smartphone, a tablet computer, a smartwatch, a laptop computer, or other electronic device or computing system capable of receiving, sending, and processing data. In other embodiments, computing device 110 may be a computing device interacting with applications and services hosted and operating in a cloud computing environment. In another embodiment, computing device 110 can be a netbook computer, a desktop computer, a personal digital assistant (PDA), or another programmable electronic device capable of generating input to and receiving programming instructions from delivery location program 300 and location preference module 200 hosted on computing device 110. Alternatively, in some embodiments computing device 110 may be communicatively connected to delivery location program 300 and location preference module 200 operating remotely on server 140. Computing device 110 may include internal and external hardware components, depicted in more detail in FIG. 4.

Computing device 120 includes camera 123, user interface 125, image 127, and location preference module 200 as a component of delivery location program 300. In some embodiments, computing device 120 is a standalone mobile computing device, a smartphone, a tablet computer, a smartwatch, a laptop computer, or other electronic device or computing system capable of receiving, sending, and processing data. In other embodiments, computing device 120 may be a computing device interacting with applications and services hosted and operating in a cloud computing environment. In another embodiment, computing device 120 can be a netbook computer, a desktop computer, a personal digital assistant (PDA), or another programmable electronic device capable of generating input to and receiving programming instructions from location preference module 200 and delivery location program 300 hosted on computing device 120. Alternatively, in some embodiments, computing device 120 may be communicatively connected to delivery location program 300 and location preference module 200 operating remotely on server 140. Computing device 120 may include internal and external hardware components, depicted in more detail in FIG. 4.

User interface 115 and user interface 125 provide an interface to access features and functions of computing device 110 and computing device 120, respectively. In some embodiments of the present invention, user interface 115 and user interface 125 provide respective access to delivery location program 300, operating on both computing device 110 and computing device 120. User interface 115 and user interface 125 also support access to other applications, features, and functions of computing device 110 and computing device 120 (not shown). User interface 115 and user interface 125 display the content exchanged between users of respective computing devices 110 and 120 sending and receiving data. In some embodiments, user interface 115 and user interface 125 display images 117 and 127 respectively.

User interface 115 and user interface 125 support access to alerts, notifications, and provides forms of communications. In one embodiment, user interface 115 and user interface 125 may be a graphical user interfaces (GUIs) or web user interfaces (WUIs) and can receive user input and display text, documents, web browser windows, user options, application interfaces, and instructions for operation, and include the information (such as graphic, text, and sound) that a program presents to a user and the control sequences the user employs to control the program. In another embodiment, user interface 115 and user interface 125 may also include mobile application software that provides respective interfaces to features and functions of computing device 110 and computing device 120. User interface 115 and user interface 125 enable respective users of computing device 110 and computing device 120 to receive, view, hear, and respond to input, access applications, display content of online conversational exchanges, and perform available functions.

Camera 113 and camera 123 are integrated features of computing device 110 and computing device 120, respectively. In various embodiments, camera 113 and camera 123 are “front” cameras of computing device 110 and computing device 120, respectively; the computing devices having a configuration that includes both front and back camera lenses. Cameras 113 and 123 are positioned on the same side of the respective computing devices as user interface 115 and user interface 125. In some embodiments, camera 113 and camera 123 include both photo and video functions and interact with additional functions of computing device 110 and computing device 120, respectively, to capture images of delivery locations at a particular delivery address, such as image 117 and image 127.

In some embodiments, camera 113 captures image 117 of a delivery location chosen by a delivery courier as a user of computing device 110 and sends image 117 to computing device 120 operated by a delivery recipient user. Image 117 indicates the delivery location chosen for the placement of delivery package 160 by the delivery courier at the delivery address. In another embodiment, image 127 is captured by camera 123 of computing device 120, operated by a delivery recipient user. Image 127 indicates a preferred or requested delivery location by the delivery recipient user, and image 127 is input to a corpus of delivery location images, with feedback by the delivery recipient person indicating a level of preference of the location.

Image 117 and image 127 include images of delivery locations associated with a delivery address. In embodiments of the present invention, image 117 is an image captured or displayed on computing device 110, and image 127 is an image captured or displayed on computing device 120. In some embodiments, image 117 may depict a delivery location selected by delivery location program 300 and displayed on user interface 115 to a delivery courier for delivery package 160. In some embodiments, image 127 may depict a delivery location image received by a recipient of delivery indicating a location of a delivered package at the delivery address. In other embodiments, image 127 may depict a preferred or requested location by the delivery recipient for packages delivered to the recipient's address. In yet other embodiments, image 127 may include annotations or feedback indicating the selection of a delivery location by the delivery courier. In some embodiments, image 117 and image 127 are stored in server 140 in a corpus of images associated with the particular delivery address and include feedback indicating relative preference of the delivery location depicted in the respective image.

Delivery address dwelling 130 is a representation of a structure of a delivery recipient at a delivery address. Delivery address dwelling 130 includes features that may serve as delivery locations and potentially facilitate hiding or obscuring delivery package 160 placed at one of the delivery locations by the delivery courier. Depicted features associated with delivery address dwelling 130 include disposal container 133, support column 135, and yard plant 137. In exemplary embodiments, a delivery courier may select one of disposal container 133, support column 135, or yard plant 137 as a delivery location to place and obscure delivery package 160. In some embodiments, delivery address dwelling 130 is a residential house. In other embodiments, delivery address dwelling 130 may be a unit within a multi-unit residential structure, and in yet other embodiments, delivery address dwelling 130 may be a business facility, government facility, or other structure to which package deliveries are made.

Disposal container 133, support column 135, and yard plant 137 are depicted as features of delivery address dwelling 130 offering potential delivery locations for delivery package 160. In some embodiments of the present invention, a delivery courier captures an image, such as image 117 captured by camera 113 of computing device 110. The captured image includes a selected delivery location, such as disposal container 133, which is used to obscure or hide delivery package 160 at delivery address dwelling 130.

Delivery location program 300 is depicted as hosted and operating on both computing device 110 and computing device 120. Delivery location program 300 includes location preference module 200, which receives a plurality of delivery location images and corresponding feedback of the delivery locations selected for a particular delivery address. Location preference module 200 generates a ranking of preferred delivery locations for the given delivery address, based on the feedback corresponding to the received images of a variety of delivery locations associated with a plurality of prior deliveries.

In some embodiments, an image of a delivery location (e.g., image 117), captured by a computing device operating delivery location program 300 is sent to a repository corpus of location preference module 200 and to a computing device of the registered delivery recipient associated with the delivery address. The image of the delivery location depicts the placement of the delivery package at the delivery address and includes a feedback component generated by the delivery recipient indicating their preference level of the delivery location chosen. The feedback is received and a ranking of delivery locations for the designated delivery address is generated and continually updated as additional delivery location images and feedback are received. In some embodiments, the feedback corresponding to the images of delivery locations includes a selectable listing of feedback options that range from very positive, to intermediate positive and intermediate negative feedback, to very negative feedback.

In an example embodiment, a delivery courier initiates delivery location program 300 and enters the delivery address. In some embodiments, delivery program 300 determines a highest-ranking delivery location associated with the delivery address, based on the feedback accumulated from previous deliveries. Delivery location program 300 identifies the preferred location for placement of the delivery package, based on the highest-ranking delivery location, and presents the image of the delivery location to the delivery courier. The delivery courier positions the delivery package according to the delivery location ranking recommended, captures a confirming image of the location and delivery location program 300 sends the image displaying the delivery package in the recommended location to the computing device of the delivery recipient. The delivery recipient activates delivery location program 300 on the respective computing device and receives, via delivery location program 300, an image of the delivery location of the delivery package. The image includes a list of feedback options ranging from very positive to very negative, and the delivery recipient user selects a feedback option and submits the delivery image and feedback to delivery location program 300, which includes the image and feedback in the corpus of location preference module 200, associated with the delivery address, and location preference module 200 updates the ranking of the delivery images.

In some embodiments of the present invention, the delivery courier may annotate an image of a delivery location to indicate preference from a delivery perspective or indicate difficulty associated with a particular delivery location. In some embodiments, the image of a delivery location may include a grid-like overlay, and a delivery courier may mark an X, Y, coordinate point to facilitate the location of a delivery package within the image. In some embodiments, a notification of a change of address of the delivery recipient is received, and delivery location program 300 dismisses the previous delivery images of the corpus associated with the previous delivery address and collects and generates a ranking of delivery locations associated with the new delivery address, via location preference module 200.

Location preference module 200 is a component of delivery location program 300 that establishes a historical baseline of preferences of delivery locations. Location preference module 200 receives images of delivery locations and feedback associated with the delivery location. In some embodiments, location preference module 200 collects a corpus of images and feedback information unique to the physical delivery address and in response to attaining a pre-determined number of images and feedback, generates a ranking of delivery locations. Ranking of delivery location images includes receiving feedback corresponding to the respective images and performing a scoring of the feedback received. The ranked delivery location images are provided to delivery location program 300, which displays the highest-ranking preference of delivery location images to the delivery courier performing the delivery of the delivery package to the delivery address.

Server 140 provides collection and storage capability for images and feedback data associated with delivery location images for the particular delivery address. In some embodiments, delivery location program 300 resides and operates remotely on server 140 and is communicatively connected to computing devices 110 and 120 (not shown). In some embodiments, the collection and storage of images and feedback data on server 140 is accessible to location preference module 200, and ranking results of the images of delivery locations are maintained on server 140 and transmitted to delivery location program 300 in communicative connection, in response to delivery location program 300 receiving a delivery address for delivery of a package.

In some embodiments, server 140 can be a web server, a blade server, a desktop computer, a laptop computer, a tablet computer, a netbook computer, or any other programmable electronic computing device capable of receiving, sending, and processing data, and communicating with computing device 110, computing device 120, and other computing devices (not shown) within distributed data processing environment 100 via network 150. In other embodiments, server 140 can represent a virtual computing device operating based on multiple computers as a server system, such as in a cloud computing environment. In another embodiment, server 140 represents a computing system utilizing clustered computers and components (e.g., database server computers, application server computers, etc.) that act as a single pool of seamless resources when accessed within distributed data processing environment 100. Server 140 may include internal and external hardware components, as depicted in more detail and described in FIG. 4.

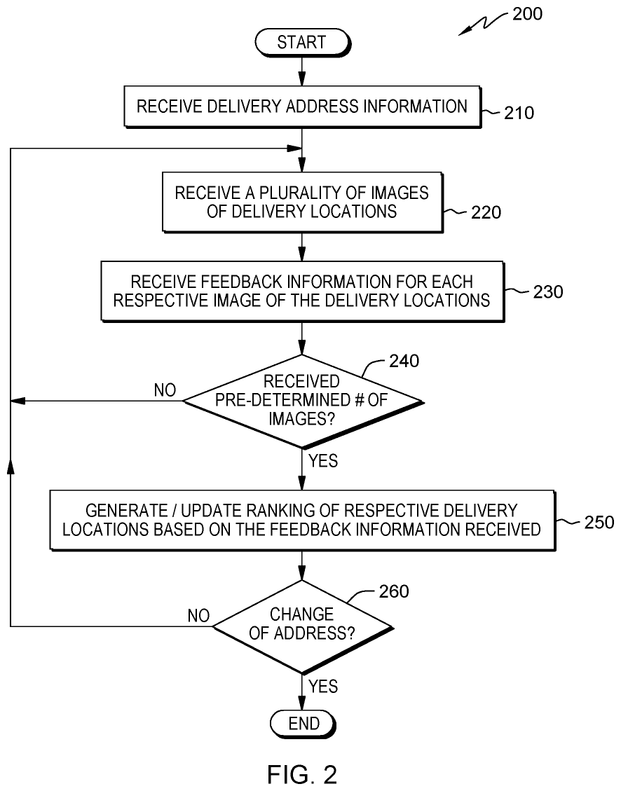

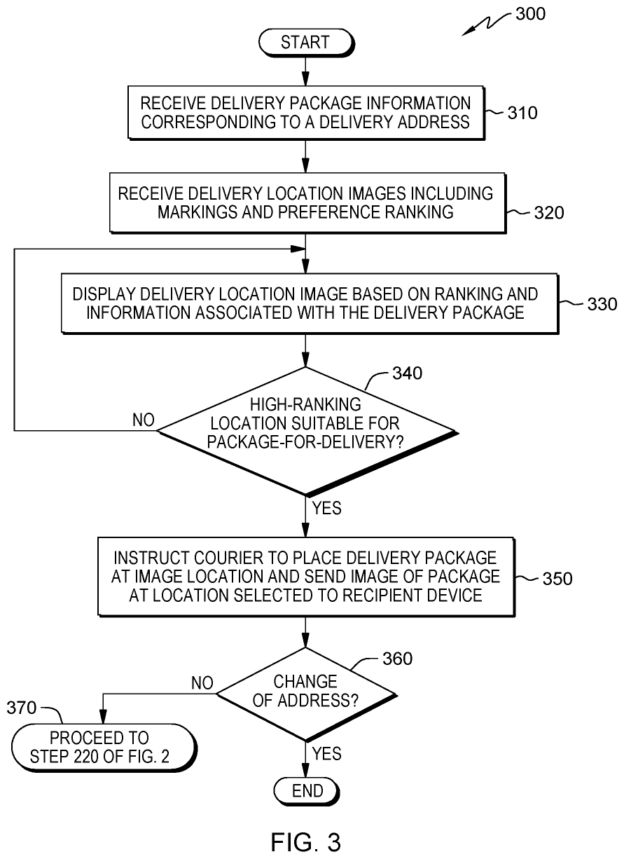

FIG. 2 is a flowchart depicting operational steps of location preference module 200 as a component of delivery location program 300 of FIG. 3, in accordance with embodiments of the present invention. Location preference module 200 iteratively receives input of delivery location images associated with a particular delivery address and feedback indicating a level of preference associated with each respective delivery location image.

Location preference module 200 receives delivery address information (step 210). Location preference module 200 receives address information that identifies a particular delivery address used for package delivery. In some embodiments, location preference module 200 receives the address information through a scanning operation of delivery package labeling. In other embodiments, the address information may be manually input.

Location preference module 200 receives a plurality of images of delivery locations (step 220). In some embodiments of the present invention, a delivery courier determines a delivery location at the recipient's address and captures an image of the delivery package positioned in the delivery location chosen. The captured image is added to a corpus of images depicting delivery locations unique to the physical delivery address. In some embodiments, the delivery courier may annotate the image of the delivery package positioned in the delivery location to communicate a preference or marking an overlay of the delivery location image to better indicate the delivery location within the image. In some embodiments, the received plurality of images of delivery locations is augmented by the delivery recipient manually inputting images of positive and negative delivery locations associated with the delivery address of the recipient to facilitate the training of location preference module 200.

Location preference module 200 receives feedback information for each respective image of the delivery locations (step 230). Location preference module 200 includes the received image in the corpus of images unique to the delivery address. Additionally, the image is processed by delivery location program 300 (discussed in detail below with respect to FIG. 3), which forwards the image to the delivery recipient's computing device and displays the image of the delivery location of the delivery package. The delivery recipient provides feedback regarding a preference level of the delivery location. In some embodiments, the feedback may be a selection of one of a range of feedback options extending, for example, from very positive, to intermediate levels, to very negative feedback associated with hiding or obscuring aspects of the delivery location in the image. In some embodiments, each option of the feedback is associated with a weighting value that is used for comparing and determining preferred delivery locations. In some embodiments, the delivery customer or delivery courier may mark or add contextual text in the content body of the image to communicate or clarify the delivery location.

For example, a weighting scheme of values from 1 to 10 may be used, with lower values corresponding to more favorable delivery locations. The delivery locations may be identified by object recognition techniques and the preference feedback for a given delivery location may be averaged over the number of instances of package delivery positioned in the particular delivery location.

Location preference module 200 determines whether a pre-determined number of images has been received (decision step 240). Location preference module 200 includes a pre-determined threshold of a number of delivery location images and feedback received to initiate the generation of a ranking of preferred delivery locations. In some embodiments in which few packages are delivered to the delivery address, or few options exist as delivery locations, the pre-determined threshold number of images may be one. In other embodiments in which delivery of packages is frequent, and/or the options for delivery locations are more abundant, the pre-determined number of received images and feedback may be five or greater, for example. Location preference module 200 tracks and determines the number of received delivery location images and corresponding feedback information.

For the case in which location preference module 200 determines that the pre-determined number of images of delivery locations has not been received (step 240, “NO” branch), location preference module 200 proceeds to step 220, waiting to receive the next delivery location image and proceeds as described above.

For the case in which location preference module 200 determines that the pre-determined number of images of delivery locations has been received (step 240, “YES” branch), location preference module 200 generates a ranking of the respective delivery locations based on the received feedback information corresponding to the delivery location images (step 250). The feedback information associated with a delivery location image includes a weighting which, in some embodiments, includes a value corresponding to a relative level of the preference of the delivery recipient with respect to the delivery location of the image. Location preference module 200 utilizes the weighting associated with the feedback information across multiple delivery locations and calculates a highest-ranking delivery location image for the particular delivery address.

In some embodiments, the feedback information may include attributes of the delivery package such as exceeding a particular size, set of dimensions, weight, or handling instructions that are received from package detail data when the delivery package is scanned by the delivery courier, or otherwise entered and associated with the delivery package. For example, a delivery package may exceed a particular weight limit and may present a lifting hazard for the delivery recipient, and an elevated delivery location may be preferred. Similarly, a preferred delivery location with a highest-ranking designation may not obscure a very large package, and an alternate delivery location may be considered. Location preference module 200 completes a ranking of all delivery location images for consideration of package attributes by a delivery courier.

Having generated or updated a ranking of delivery location images based on the feedback information, location preference module 200 checks whether the delivery address recipient has indicated a change of delivery address (decision step 260). In some embodiments of the present invention, the recipient of the delivery address indicates a change of address via delivery location program 300 operating on a computing device of the recipient, and communicatively connected to location preference module 200. For the case in which location preference module 200 determines that the recipient delivery address has not changed (step 260, “NO” branch), location preference module 200 returns to step 220 and waits for receipt of an image of a delivery location.

For the case in which location preference module 200 determines that a change of address for the recipient has been received (step 260, “YES” branch), location preference program 200 removes association of the delivery location images and feedback from the delivery address of the recipient and builds a new corpus of delivery location images based on the new delivery address for the recipient. In some embodiments, an optional feature of location preference module 200 includes maintaining historic images of delivery locations subsequent to a change of address of the previous delivery recipient. A new owner of the delivery address may request access and review of previous delivery location images if retained and provide feedback information to the respective images enabling a corpus of delivery location images for location preference module 200 associated with the new recipient of the delivery address. In some embodiments, the departing recipient of the delivery address designates the deletion of all previous delivery location images and feedback data.

FIG. 3 is a flowchart depicting operational steps of delivery location program 300, operating in the distributed data processing environment of FIG. 1 and includes location preference module 200 of FIG. 2, in accordance with embodiments of the present invention. Delivery location program 300 receives delivery package information corresponding to a particular delivery address (step 310). Delivery location program 300 receives information associated with the delivery package indicating the physical address of delivery (delivery address) and information associated with attributes of the delivery package. In some embodiments, the delivery package information includes a geo-fence indicating the extent of an area associated with the delivery package recipient residing at the delivery address. For example, in multiple-unit residential structures, the area in which delivery locations are considered may be defined by geofence data. In some embodiments, the delivery package information includes data associated with attributes of the delivery package, such as weight, dimensional size and shape, and whether contents may be perishable.

Delivery location program 300 receives delivery location images including markings and preference ranking (step 320). Delivery location program 300 receives from location preference module 200 delivery location images associated with the delivery address. In one embodiment, delivery location program 300 receives a highest-ranking delivery location image from location preference module 200. In some embodiments, delivery location program 300 receives a plurality of delivery location images organized in a listed sequence from highest-ranking by preference to lower-ranking delivery location images by preference. In some embodiments, the delivery location images include markings indicating a precise location or designating information that may relate to delivery package attributes. For example, delivery location program 300 receives from location preference module 200 a listing of delivery locations for the address associated with delivery address dwelling 130 (FIG. 1). Delivery location program 300 receives delivery location images and ranked preference for disposal container 133, support column 135, and yard plant 137.

Delivery location program 300 displays a delivery location image based on preference ranking and information associated with the delivery package (step 330). Delivery location program 300 determines the highest preference ranking of the received delivery location images and displays the delivery image on the device of the delivery courier. In some embodiments, delivery location program 300 also includes markings or annotations along with the display of the delivery location image having the highest preference ranking. The markings or annotations may indicate a concern with using the particular delivery location based on attributes of the delivery package. For example, the delivery location may place the package in very warm, direct sunlight, and the package may have attributes of perishable contents. The annotations may discourage the use of the delivery location for delivery packages having this attribute. In an example embodiment, a delivery location of yard plant 137 (FIG. 1) is indicated as having the highest preference ranking but also includes information discouraging this delivery location for delivery packages with a perishable attribute.

In some embodiments of the present invention, attributes of the delivery package that exceed a pre-determined threshold (i.e., weight, height, width, heat-perishable) may trigger delivery location program 300 to include an annotation of the attribute along with the display of the delivery location image

Delivery location program 300 determines whether the high-ranking delivery location is suitable for the delivery package (decision step 340). In some embodiments, delivery location program 300 applies character recognition to annotations overlaid or combined with delivery location images to determine attribute conditions associated with the delivery location. Similarly, the received delivery package information is processed by delivery location program 300 to identify attributes associated with the delivery package. Delivery location program 300 determines whether the displayed delivery location is suitable for the delivery package, based on the preference ranking of the delivery location. Suitable conditions may include whether the delivery location obscures the delivery package to an extent that protects recognition of the package by observers and passers-by of the delivery address. Suitable conditions may also include whether the lifting of the delivery package from the delivery location poses a risk to the recipient, or whether exposure to the elements may adversely affect the contents of the delivery package.

For the case in which delivery location program 300 determines that the high-ranking preferred delivery location is not suitable for the delivery package (step 340, “NO” branch), delivery location program 300 returns to step 330 and displays an alternate delivery location (step 330). In some embodiments, delivery location program 300 may select a delivery location with a lower preference level (still positive preference) but more suitable to the attributes associated with the delivery package. In some embodiments, delivery location program 300 may indicate the highest-ranking preference of delivery locations is not appropriate for the delivery package and alert the delivery courier.

In some embodiments of the present invention, attributes of the delivery package that exceed a pre-determined threshold (i.e., weight, height, width, heat-perishable) may trigger delivery location program 300 to alternatively prioritize a lower-ranking delivery location image that indicates a positive level of preference and is consistent with accommodating the violated threshold of the attribute. For example, the highest-ranking delivery location image indicates a high preference for the delivery package to be placed behind yard plant 137 (FIG. 1), however, package information indicates that the contents are perishable, and a shaded delivery location is preferable. Location preference module 200, acknowledging the attributes of the perishable content of the delivery package information, selects a delivery location of support column 135, which indicates positive feedback, but not as highly ranked as yard plant 137.

In one embodiment, the delivery courier, viewing the delivery location recommended by delivery location program 300 and considering the information associated with the delivery package, manually inputs to delivery location program 300 that the location is not suitable. In another embodiment, delivery location program 300 presents all positive preference delivery location images listed according to the ranking of preference and includes annotations associated with respective delivery locations.

For the case in which delivery location program 300 determines that the highest-ranking delivery location is suitable for the delivery package (step 340, “YES” branch), delivery location program 300 instructs the delivery courier to place the delivery package at the location corresponding to the delivery location image selected, capture a new image of the delivery package placed at the delivery location, and sends the new image of the delivery package at the delivery location to the device of the recipient (step 350). Having displayed the highest-ranking delivery location image, delivery location program 300 presents instructions to position the delivery package in the selected delivery location, and for the delivery courier to capture a new image of the delivery location with the delivery package in place. Delivery location program 300 sends the new image to the delivery address recipient's computing device.

For example, delivery location program 300 displays the delivery location image of disposal container 133 on user interface 115 of computing device 110. Delivery location program 300 additionally displays instructions directed to the delivery courier using computing device 110 to capture a new image, using camera 113, of the delivery package positioned in the delivery location behind disposal container 133. Delivery location program 300 receives the new image and sends the image to user interface 125 of computing device 120 operated by the recipient at delivery address dwelling 130, indicating the location of the delivery package with intent to obscure the location from others. The recipient views the new image, retrieves the delivery package and provides feedback associated with the new image. Delivery location program 300 receives the feedback input and sends the new image and feedback to location preference module 200, and the image and feedback are included in the corpus of delivery location images for delivery address dwelling 130.

Delivery location program 300 checks to determine whether a change of address for the recipient has been received (step 360). Subsequent to completing the delivery of the delivery package, delivery location program 300 maintains a “listen” mode to detect whether a change of address notification is received associated with the recipient of the delivery address. In the case in which a delivery address is received, the corpus of delivery location images is dissociated with the recipient, and a new delivery address is established with the recipient, and a new corpus of delivery locations associated with the new delivery address, is built via location preference module 200. Subsequent to determining a change of address for the recipient at the (former) delivery address, delivery location program 300 ends with respect to the former delivery address.

For the case in which no change of address indication is received, delivery location program 300 returns to step 220 of location preference module 200 and proceeds as described above. Delivery location program 300 returns to location preference module 200 and includes the new delivery location image and feedback in the corpus of delivery images. The new delivery image is included in updates to the preference ranking of delivery locations.

Some embodiments of the present invention may also include the following additional features.

In some embodiments, a highest-ranked preference delivery location may require adjustment by the recipient at the delivery address, and the recipient may submit a plurality of images of delivery locations with adjusted preference feedback, influencing the ranking of delivery locations at the delivery address. For example, the recipient at the delivery address has sustained an injury and cannot bend and lift a delivery package from a ground-level position. The recipient may capture and submit to location preference module 200 via delivery location program 300, a plurality of images of delivery locations that were previously preferred but are now given a low or very low preference feedback rating, whereas high preference may be given to a delivery location that does not require bending and lifting of the delivery package, such as a table (not shown in figures). The ranking of preferred delivery locations may evolve based on the needs and preferences of the recipient via input to delivery location program 300.

In some embodiments, the size and shape of the delivery package may be determined by the capture of an image of the package and use of auto-focus features of the camera function of the computing device, such as camera 113 of computing device 110. Additionally, the size and shape of objects in the geo-fence domain of the delivery address may be similarly determined from image captures, and new delivery locations to hide or obscure the delivery package may be determined based on size and/or shape match. The match between the delivery package image and an object in the geo-fence domain may be presented to the delivery courier in an image in which the package image is overlaid or positioned adjacently to the delivery location object.

In some embodiments, the coloring or patterning of the delivery package may be matched with coloring and/or patterning of objects within a geo-fence of the delivery address. Delivery location program 300 may present an image of the delivery location with coloring and/or patterning with the delivery package positioned adjacent to indicate a potential delivery location to obscure the package from obvious detection.

In some embodiments, a delivery recipient may opt-in to an available packaging product that may aid in obscuring the delivery package. For example, a bark-pattern camouflage bag may be placed over a brown cardboard delivery package and placed in front of the base of one or a group of trees. Or alternatively, a box with decorative flower images on the exterior may be used to hold the typical cardboard box of the delivery package, and the flower-decorated box may be positioned in a small flower garden adjacent to the entrance of the delivery address.

FIG. 4 depicts a block diagram of components of computing system 400, including computing device 405, configured to include or operationally connect to components depicted in FIG. 1, and capable of performing operational steps of location preference module 200 and delivery location program 300 of FIG. 3, in accordance with an embodiment of the present invention, in accordance with an embodiment of the present invention.

Computing device 405 includes components and functional capability similar to components of computing device 110 (FIG. 1), in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 405 includes communications fabric 402, which provides communications between computer processor(s) 404, memory 406, persistent storage 408, communications unit 410, an input/output (I/O) interface(s) 412. Communications fabric 402 can be implemented with any architecture designed for passing data and/or control information between processors (such as microprocessors, communications, and network processors, etc.), system memory, peripheral devices, and any other hardware components within a system. For example, communications fabric 402 can be implemented with one or more buses.

Memory 406, cache memory 416, and persistent storage 408 are computer-readable storage media. In this embodiment, memory 406 includes random access memory (RAM) 414. In general, memory 406 can include any suitable volatile or non-volatile computer-readable storage media.

In one embodiment, location preference module 200 and delivery location program 300, are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of distributed data processing environment 100. In these examples, communications unit 410 includes one or more network interface cards. Communications unit 410 may provide communications through the use of either or both physical and wireless communications links. Location preference module 200 and delivery location program 300 may be downloaded to persistent storage 408 through communications unit 410.

I/O interface(s) 412 allows for input and output of data with other devices that may be connected to computing system 400. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., location preference module 200 and delivery location program 300 can be stored on such portable computer-readable storage media and can be loaded onto persistent storage 408 via I/O interface(s) 412. I/O interface(s) 412 also connects to a display 420.

Display 420 provides a mechanism to display data to a user and may, for example, be a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method to determine a placement of a delivered item, the method comprising:
receiving, by a first computing device, a plurality of delivery location images from prior deliveries associated with a delivery address, wherein a respective delivery location image depicts a delivery location at the delivery address and includes feedback of a preference level of the delivery location;
generating, by the first computing device, a ranking of the plurality of delivery location images, based on respective preference levels of the plurality of delivery location images;
receiving, by the first computing device, information associated with a delivery of a first package to the delivery address;
determining, by the first computing device, a first delivery location associated with the delivery address, the first delivery location having a highest-ranking of preference level, based on the feedback of the preference level of the of the delivery location depicted in the respective delivery location image of the plurality of delivery location images;
sending, by the first computing device to a second computing device associated with the delivery address, a first image of the first delivery package placed in the first delivery location; and
receiving, by the first computing device from the second computing device, a first feedback of preference level of the first delivery location included in the first image of the first delivery package.

2. The method of claim 1, wherein receiving the information associated with the first package designated for the delivery address further comprises:
receiving, by the first computing device, attributes associated with the first delivery package;
determining, by the first computing device, whether the first delivery location, which corresponds with the highest-ranking of preference level, is suitable for the attributes associated with the first delivery package; and
in response to determining that the first delivery location with the highest-ranking of preference level is not suitable for the attributes associated with the first delivery package, presenting, by the first computing device, a listing of additional delivery locations with positive preference level ranking.

3. The method of claim 2, wherein the attributes associated with the first delivery package include a combination selected from a group consisting of a size, a shape, a color, an exterior pattern, and a weight.

4. The method of claim 1, wherein the feedback of the preference level of the delivery location corresponding to the respective delivery location image of the plurality of delivery location images includes options of preference level selectable from a list.

5. The method of claim 1, wherein the delivery location corresponding to the respective delivery location image of the plurality of delivery location images are within a defined geofence associated with the delivery address.

6. The method of claim 1, wherein receiving the ranking of the respective delivery location images associated with the delivery address, further comprises:
sending, by the first computing device to the second computing device, a plurality of images, each image including image objects of a delivery package placed in a respective delivery location of the plurality of delivery locations associated with the delivery address; and
receiving, by the first computing device from the second computing device, a set of images of the plurality of images, each received image of the set of images including the feedback of the preference level of the respective delivery location at the delivery address associated with the received image of the set of images.

7. The method of claim 6, further comprising:
determining, by the first computing device, whether a pre-determined threshold number of images of the set of images including the feedback of the preference level of respective delivery locations at the delivery address has been received; and
in response to determining the pre-determined threshold number of images of the set of images has been received, initiating, by the first computing device, generation of a ranking of the set of images including the feedback of the preference level of the respective delivery locations at the delivery address.

8. A computer program product to determine a placement of a delivered item, the method comprising:
one or more computer-readable storage media; and
program instructions stored on the one or more computer-readable storage media, the program instructions comprising:
program instructions to receive a plurality of delivery location images from prior deliveries associated with a delivery address, wherein a respective delivery location image depicts a delivery location at the delivery address and includes feedback of a preference level of the delivery location
program instructions to generate a ranking of the plurality of delivery location images, based on respective preference levels of the plurality of delivery location images;
program instructions to receive information associated with a delivery of a first package to the delivery address;
program instructions to determine a first delivery location associated with the delivery address, the first delivery location having a highest-ranking of preference level, based on the feedback of the preference level of the of the delivery location depicted in the respective delivery location image of the plurality of delivery location images;
a first delivery location associated with the delivery address and having a highest-ranking of preference level, based on the feedback of the preference level of the corresponding delivery location associated with the respective delivery location image of the plurality of delivery location images;
program instructions to send to a second computing device associated with the delivery address, a first image of the first delivery package placed in the first delivery location; and
program instructions to receive from the second computing device, a first feedback of preference level of the first delivery location included in the first image of the first delivery package.

9. The computer program product of claim 8, wherein the information associated with the first package designated for the delivery address further comprises:
program instructions to receive attributes associated with the first delivery package;
program instructions to determine whether the first delivery location, which corresponds with the highest-ranking of preference level, is suitable for the attributes associated with the first delivery package; and
in response to determining that the first delivery location with the highest-ranking of preference level is not suitable for the attributes associated with the first delivery package, program instructions to present a listing of additional delivery locations with positive preference level ranking.

10. The computer program product of claim 9, wherein the attributes associated with the first delivery package include a combination selected from a group consisting of a size, a shape, a color, an exterior pattern, and a weight.

11. The computer program product of claim 8, wherein the feedback of the preference level of the delivery location corresponding to the respective delivery location image of the plurality of delivery location images includes options of preference level selectable from a list.

12. The computer program product of claim 8, wherein the delivery location corresponding to the respective delivery location image of the plurality of delivery location images is within a defined geofence associated with the delivery address.

13. The computer program product of claim 8, wherein the program instructions to receive the ranking of the respective delivery location images associated with the delivery address, further comprises:
program instructions to send to the second computing device, a plurality of images, each image including image objects of a delivery package placed in a respective delivery location of the plurality of delivery locations associated with the delivery address; and
program instructions to receive from the second computing device, a set of images of the plurality of images, each received image of the set of images including the feedback of the preference level of the respective delivery location at the delivery address associated with the received image.

14. The computer program product of claim 13, further comprising:
program instructions to determine whether a pre-determined threshold number of images of the set of images including the feedback of the preference level of respective delivery locations at the delivery address has been received; and
in response to determining the pre-determined threshold number of images of the set of images has been received, program instructions to initiating generation of a ranking of the set of images including the feedback of the preference level of the respective delivery locations at the delivery address.

15. A computer system to determine a placement of a delivered item, the computer system comprising:
one or more computer processors;
one or more computer-readable storage media; and
program instructions stored on the one or more computer-readable storage media, the program instructions comprising:
program instructions to receive a plurality of delivery location images from prior deliveries associated with a delivery address, wherein a respective delivery location image depicts a delivery location at the delivery address and includes feedback of a preference level of the delivery location
program instructions to generate a ranking of the plurality of delivery location images, based on respective preference levels of the plurality of delivery location images;
program instructions to receive information associated with a delivery of a first package to the delivery address;
program instructions to determine a first delivery location associated with the delivery address, the first delivery location having a highest-ranking of preference level, based on the feedback of the preference level of the of the delivery location depicted in the respective delivery location image of the plurality of delivery location images;
a first delivery location associated with the delivery address and having a highest-ranking of preference level, based on the feedback of the preference level of the corresponding delivery location associated with the respective delivery location image of the plurality of delivery location images;
program instructions to send to a second computing device associated with the delivery address, a first image of the first delivery package placed in the first delivery location; and
program instructions to receive from the second computing device, a first feedback of preference level of the first delivery location included in the first image of the first delivery package.

16. The computer system of claim 15, wherein the information associated with the first package designated for the delivery address further comprises:
program instructions to receive attributes associated with the first delivery package;
program instructions to determine whether the first delivery location, which corresponds with the highest-ranking of preference level, is suitable for the attributes associated with the first delivery package; and
in response to determining that the first delivery location with the highest-ranking of preference level is not suitable for the attributes associated with the first delivery package, program instructions to present a listing of additional delivery locations with positive preference level ranking.

17. The computer system of claim 16, wherein the attributes associated with the first delivery package include a combination selected from a group consisting of a size, a shape, a color, an exterior pattern, and a weight.

18. The computer system of claim 15, wherein the delivery location corresponding to the respective delivery location image of the plurality of delivery location images is within a defined geofence associated with the delivery address.

19. The computer system of claim 15, wherein the program instructions to receive the ranking of the respective delivery location images associated with the delivery address further comprises:
program instructions to send to the second computing device, a plurality of images, each image including image objects of a delivery package placed in a respective delivery location of the plurality of delivery locations associated with the delivery address; and
program instructions to receive from the second computing device, a set of images of the plurality of images, each received image of the set of images including the feedback of the preference of the respective delivery location at the delivery address associated with the received image.

20. The computer system of claim 19, further comprising:
program instructions to determine whether a pre-determined threshold number of images of the set of images including the feedback of the preference level of respective delivery locations at the delivery address has been received; and
in response to determining the pre-determined threshold number of images of the set of images has been received, program instructions to initiate generation of a ranking of the set of images including the feedback of the preference level of the respective delivery locations at the delivery address.
